(19) United States
(12) Patent Application Publication
(10) Pub. No.: US 2005/0087513 A1
(43) Pub. Date: Apr. 28, 2005

(54) Method of forming transparent conductive layer on substrate

(76) Inventors: Tsung-Neng Liao, Shengang Township (TW); Jyh-Luen Chen, Taipei City (TW); Chun-Chi Lee, Taipei City (TW)

Correspondence Address: BIRCH STEWART KOLASCH & BIRCH, PO BOX 747, FALLS CHURCH, VA, 22040-0747, US

(21) Appl. No.: 10/681,118

(22) Filed: Oct. 9, 2003

(51) Int. Cl. B05D 5/12

(52) U.S. Cl. 216/54

(57) ABSTRACT

A method of forming a transparent conductive layer on a substrate has the steps of: forming a transparent conductive layer on a flat surface of a temporary substrate, wherein the transparent conductive layer has a first side attached onto the flat surface directly and a second side opposite to the first side; patterning the transparent conductive layer; providing an insulation layer to cover the second side of the transparent conductive layer; providing a substrate on the insulation layer, and removing the temporary substrate to expose the first side of the transparent conductive layer.

### BACKGROUND OF THE INVENTION

1. Field of the Invention

The present invention relates to an organic light emitting diode display (OLED), and more particularly to a method of forming a transparent conductive layer on a substrate, which the transparent conductive layer has a smooth top surface without the further smoothing process.

2. Description of the Related Art

A conventional active or passive type organic light emitting diode display is mainly consisted of an emissive light emitting device, wherein the emissive light emitting device has a substrate and a transparent anode layer, a light emitting layer and a metal cathode layer are foamed on the substrate in sequence. The transparent anode layer is made of Indium Tin Oxide (ITO) and the metal cathode layer is made of magnesium (Mg), silver (Ag), aluminum (Al) or the alloy.

The ITO layer is usually made by the sputtering method to be formed on the substrate and the ITO layer has a rough top surface. Electric discharges are occurred at spike points of the ITO layer while a voltage is added to the ITO layer and the metal cathode layer and that makes the light emitting layer providing light source having dark spots.

The ITO layer is required to have a top surface having a smaller surface roughness to prevent the point discharge so that a mechanical polishing process is applied thereto to smooth the top surface. The mechanical polishing process has its limitation to smooth the surface. The top surface of the ITO layer is hard to get the required surface roughness by the mechanical grinding procedure, especially for a top surface of large area.

### SUMMARY OF THE INVENTION

The primary objective of the present invention is to provide a method of forming a transparent conductive layer on a substrate, which the transparent conductive layer has a top surface having a smaller surface roughness.

According to the objective of the present invention, a method of forming a transparent conductive layer on a substrate comprises the steps of: forming a transparent conductive layer on a flat surface of a temporary substrate, wherein the transparent conductive layer has a first side attached onto the flat surface directly and a second side opposite to the first side; providing a substrate on the second side of the transparent conductive layer, and removing the temporary.

### BRIEF DESCRIPTION OF THE DRAWINGS

FIG. 1 is a flow chart of a preferred embodiment the present invention;

FIG. 2 is a sectional view of the preferred embodiment of the present invention, showing the transparent conductive layer formed on the temporary substrate;

FIG. 2A is an enlarged view in part of FIG. 2;

FIG. 3 is a sectional view following FIG. 2, showing the transparent conductive layer being patterned;

FIG. 4 is a sectional view following FIG. 3, showing the insulation layer being formed on the temporary substrate to cover the transparent conductive layer;

FIG. 5 is a sectional view following FIG. 4, showing the substrate coupled with the insulation layer;

FIG. 6 is a sectional view following FIG. 5, showing the temporary substrate being removed;

FIG. 6A is an enlarged view in part of FIG. 6, and

FIG. 7 is a sectional view following FIG. 6, showing the light emitting layer and the cathode layer being formed on the first side of the transparent conductive layer in sequence.

### DETAILED DESCRIPTION OF THE INVENTION

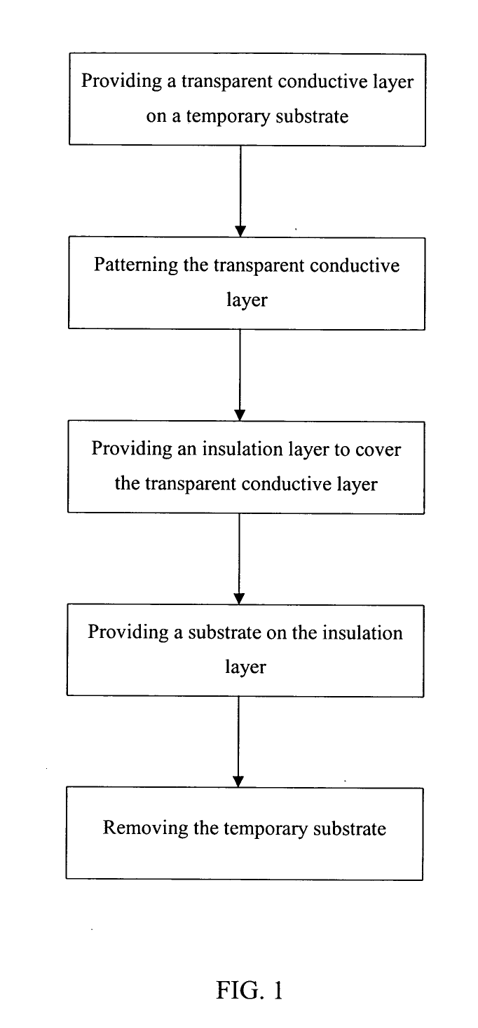

As shown in FIG. 1, a method of forming a transparent conductive layer on a substrate of the preferred embodiment of the present invention comprises the steps of:

A. Form a transparent conductive layer 20 on a temporary substrate 10:

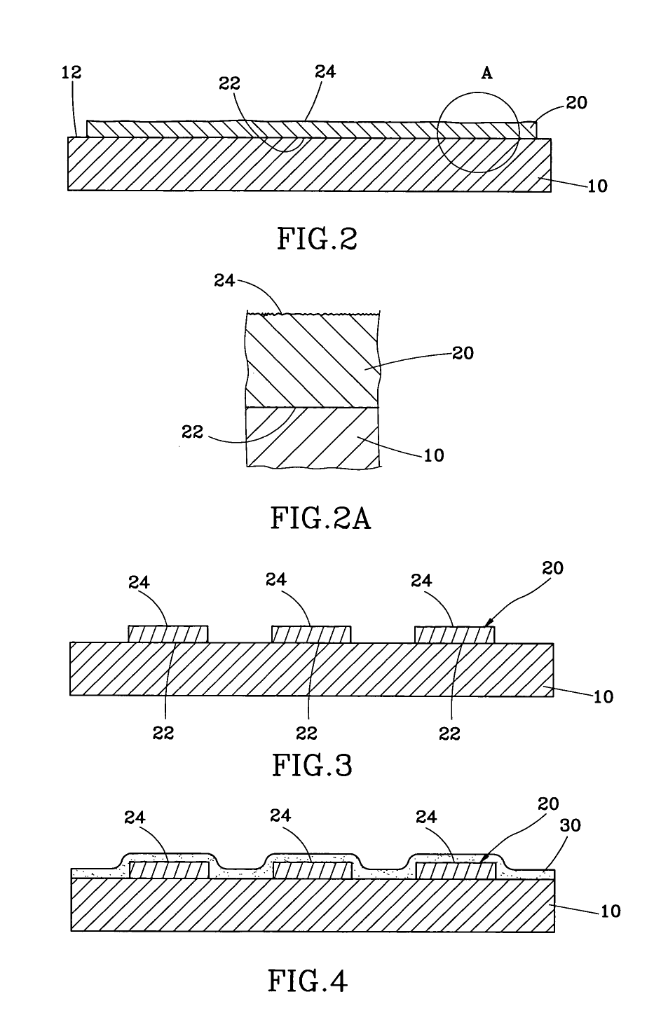

As shown in FIG. 2, the temporary substrate 10 is made of silicon wafer, glass, quartz glass or metal etc. The temporary substrate 10 has a flat surface 12 with an average surface roughness (Ra) less 10 nm, and more preferred average surface roughness is less than 5 nm. The transparent conductive layer 20 is preferred made of Indium Tin Oxide (ITO) and made by a sputtering process, an evaporation process, a chemical vapor deposition process or a sol-gel process etc. There is an ITO glass in the market and the ITO glass can be applied to the present invention directly.

As shown in FIG. 2A, the transparent conductive layer 20 has a first side 22 and a second side 24 opposite to the first side 22, wherein the first side 22 of the transparent conductive layer 20 is attached onto the flat surface 12 of the temporary 10 directly so that the fist side 22 has an average surface roughness similar to the average surface roughness of the flat surface 12 and the second side 24 has an average surface roughness larger than the first side 22.

B. Remove predetermined portions of the transparent conductive layer 20 to form a pattern:

As shown in FIG. 3, a conventional photo etching process is applied to the transparent conductive layer 20 to remove the predetermined portions of the transparent conductive layer 20. The transparent conductive layer 20 now forms a pattern.

C. Provide an insulation layer 30 to cover the transparent conductive layer 20:

As shown FIG. 4, the insulation layer 30 is made of silicon dioxide (SiO₂), Silicon nitride (SiNx), polymer, diamond and diamond like carbon etc. The insulation layer 30 is provided on the temporary substrate 10 by a sputtering process, an evaporation process, a chemical vapor deposition process or a sol-gel process etc. such that the insulation layer 30 covers the second side 24 of the transparent conductive layer 20.

The purpose of the insulation layer 30 is to isolate water vapor and gas so that the temporary substrate 10 can be provided with several insulation layers 30 of various materials thereon to enhance the isolation function.

D. Provide a substrate 40 on the insulation layer 30:

The substrate 40 is made of glass, plastic or flexible plastic film etc. and is coupled with the insulation layer 30 by direct bonding, anodic bonding, low temperature bonding, Intermediate bonding, Adhesive bonding and laser bonding etc.

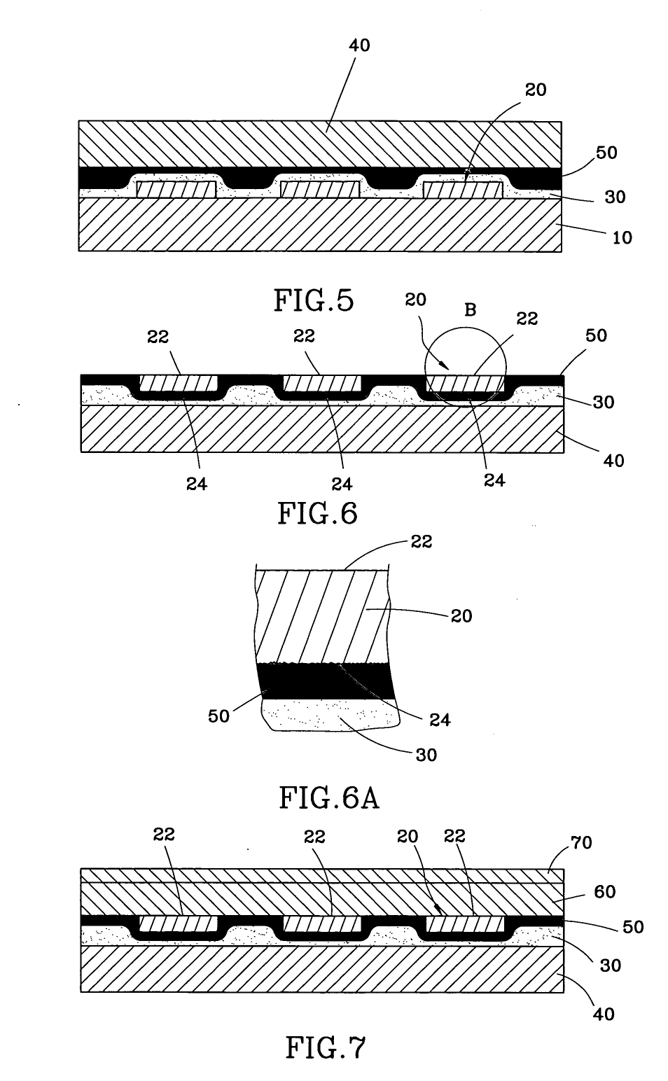

As shown in FIG. 5, the substrate 40 is bonded to the insulation layer 30 by glue so that there is an adhesive layer 50 between the substrate 40 and the insulation layer 30 in the present invention. The adhesive layer 50 has both functions of firmly bonding the substrate 40 to the insulation layer 30 and providing flexibility, therefore, there is a superior flexibility while the present invention is applied to a flexible flat panel display.

E. Remove the temporary substrate 10:

The temporary substrate 10 is removed by means of a grinding process (lapping or polishing) or an etching process. The etching process can be a chemical etching process or a plasma etching. If the temporary substrate 10 is made of glass, the chemical etching process uses hydrofluoric acid (HF) solution as the etching agent. The hydrofluoric acid solution attacks the temporary substrate 10 but hardly attacks the transparent conductive layer 20 so that we recommend that the grinding process (lapping or polishing) is applied to the temporary substrate 10 first for fast and mass removal of the temporary substrate 10, and then the etching process is applied thereto for removal the residual temporary substrate 10.

As shown in FIG. 6 and FIG. 6A, after the temporary substrate 10 has been removed, the first side 22 of the transparent conductive layer 20, which the average surface roughness is smaller, is exposed and the second side 24 thereof, which the average surface roughness is greater, is hidden at an interior. According to our test, the average surface roughness (Ra) of the first side 22 of the transparent conductive layer 20 is 1 nm or less, and is preferred less than 0.5 nm. The peak-to-valley roughness (Rpv) of the first side 22 of the transparent conductive layer 20 is 10 nm or less, and is preferred less than 6 nm.

After the steps above, we would get a product of the substrate 40 having the transparent conductive layer 20 thereon and the transparent conductive layer 20 having a smooth top surface (i.e. the first side 22) as shown in FIG. 6. The product of the present invention can be further made into an emissive light emitting device as shown in FIG. 7. A light emitting layer 60 is provided onto the first side 22 of the transparent conductive layer 20 and a back cathode layer 70, such that voltage is added to the transparent conductive layer 20 and the back cathode layer 70 to make the light emitting layer 60 lighting.

There are several characters of the present invention to be mentioned hereunder:

The main character of the present invention is to form a smooth first side 22 on the transparent conductive layer 20 means of the flat surface 12 of the temporary substrate 10 (Step A), and then transfer the transparent conductive layer 20 from the temporary substrate 10 to the substrate 40. In the transference, the smooth first side 22 of the transparent conductive layer 20 is turned to the exterior from the interior (Step D). At last, the temporary substrate 10 is removed to get the substrate 40 having the transparent conductive layer 20 thereon and the transparent conductive layer 20 having a smooth top surface (the fist side 22). Whereby, there is less point discharge occurred on the fist side 22 of the transparent conductive layer 20 while a voltage is added to the transparent conductive layer 20.

The Step B depends on the requirement of whether the transparent conductive layer 20 has to be formed a pattern. An alternate procedure is to pattern the transparent conductive layer 20 (Step B) after it is transferred from the temporary substrate 10 to the substrate 40 (Step E). But we recommend that to pattern the transparent conductive layer 20 while it is still on the temporary substrate 10.

The adhesive layer 50 serves both functions of isolation and coupling, except that the adhesive layer 50 further has a function of isolation like the insulation layer 40 do. It is possible to replace the insulation layer 40 with the adhesive layer 50 because the adhesive layer 50 serves all of the functions of the insulation layer 40.

1. A method of forming a transparent conductive layer on a substrate, comprising the steps of:
providing a transparent conductive layer on a temporary substrate, wherein the temporary substrate has a flat surface and the transparent conductive layer has a first side attached on the flat surface of the temporary substrate and a second side opposite to the first side;
providing a substrate on the second side of the transparent conductive layer, and
removing the temporary substrate.

2. The method as defined in claim 1, further comprising the step of patterning the transparent conductive layer.

3. The method as defined in claim 1, further comprising the step of providing an insulation layer between the second side of the transparent conductive layer and the substrate.

4. The method as defined in claim 3, further comprising the step of providing an adhesive layer between the substrate and the insulation layer.

5. The method as defined in claim 4, wherein the adhesive layer has a suitable flexibility.

6. The method as defined in claim 1, further comprising the step of providing an adhesive layer between the second side of the transparent conductive layer and the substrate.

7. The method as defined in claim 6, wherein the adhesive layer has a suitable flexibility.

8. The method as defined in claim 1, wherein the temporary substrate is removed by a grinding process first, and then by an etching process

9. The method as defined in claim 1, wherein the flat surface of the temporary substrate has an average surface roughness less than 10 nm.

10. The method as defined in claim 1, wherein the first side of the transparent conductive layer has an average surface roughness less than 1 nm.

11. The method as defined in claim 1, wherein the first side of the transparent conductive layer has an average surface roughness less than 0.5 nm.
